(19) United States
(12) Patent Application Publication
(10) Pub. No.: US 2019/0026198 A1
(43) Pub. Date: Jan. 24, 2019

(54) Method and device for configuring an execution means and for detecting a state of operation thereof

(71) Applicants: Robert Bosch GmbH, Stuttgart (DE); Fraunhofer-Gesellschaft zur Foerderung der angewandten Forschung e.V., Muenchen (DE)

(72) Inventors: Mikkel Liisberg, Stuttgart (DE); Peter Munk, Stuttgart (DE); Eike Martin Thaden, Renningen (DE); Markus Schweizer, Vaihingen/Enz (DE); Christoph Dropmann, Limburgerhof (DE); Jasmin Jahic, Kaiserslautern (DE); Denis Uecker, Kaiserslautern (DE); Christian Peper, Kaiserslautern (DE)

(73) Assignees: Robert Bosch GmbH, Stuttgart (DE); Fraunhofer-Gesellschaft zur Foerderung der angewan dten Forschung e.V., Muenchen (DE)

(21) Appl. No.: 16/037,475

(22) Filed: Jul. 17, 2018

(30) Foreign Application Priority Data
Jul. 18, 2017 (DE) 10 2017 116 081.7

(51) Int. Cl. G06F 11/16; G06F 9/54

(52) U.S. Cl. CPC G06F 11/1641; G06F 9/546; G06F 11/165

(57) ABSTRACT

A method/device for configuring at least one execution unit for detecting a state of operation of the one execution unit, the method/device comprising at least assigning a first replica of an item of application software for the purpose of execution on at least one computing core of the execution unit depending on information relating to at least one item of hardware or relating to at least one operating system of the execution unit assigning a second replica of the application software for the purpose of execution on the computing core of the execution unit depending on the information relating to the at least one item of hardware or relating to the operating system of the execution unit.

### PRIOR ART

Security-related computing systems are highly reliable. Said computing systems are designed to achieve the FIT (Failures In Time) rate required by ISO 26262-1:2011, for example. In order to detect random internal computing errors, hardware lockstep mechanisms are used in which the same machine instructions are redundantly executed in parallel with various computing cores of a multicore processor of the computing system. A hardware lockstep comparator detects when internal states or results of the computing cores differ from one another. An error handling operation evaluates said differences detected by the hardware lockstep comparator and for example carries out an error handling operation.

WO2007017372, US2007174837A and US2009217092A disclose lockstep mechanisms which simulate a hardware lockstep mechanism of this kind or that implement an error handling operation by means of redundant calculations. In this case, first of all, applications for a redundant calculation are replicated. Afterwards, all input data for the applications are provided. Subsequently, redundant calculation takes place. In a final step, a comparator, i.e. is hardware lockstep comparator or a simulation of a hardware lockstep comparator, compares the computing results of all applications. Error handling then follows.

Said known methods are set to an input-process-output model, in which error detection is possible either by means of a hardware lockstep mechanism, a simulation of a hardware lockstep mechanism or by means of redundant calculation after execution of the application.

However, it is desirable to provide improved methods which are not bound to a predefined input-process-output model and which can alternatively be executed on computing systems comprising and not comprising a hardware lockstop comparator.

### DISCLOSURE OF THE INVENTION

This is achieved by a method or a device for configuring an execution unit or for detecting a state of operation of said execution unit according to the independent claims.

The execution units comprise computing cores of a multicore processor or various processors. The execution units are configured to execute a software lockstep method, by means of which a state of operation, for example an error state or an error-free state, is detected.

The method for configuring at least one execution unit for detecting a state of operation of the at least one execution unit comprises the steps of: assigning a first replica of an item of application software for the purpose of execution on at least one computing core of the at least one execution unit depending on information relating to at least one item of hardware or relating to at least one operating system of the at least one execution unit, assigning a second replica of the application software for the purpose of execution on the at least one computing core of the at least one execution unit depending on the information relating to the at least one item of hardware or relating to the at least one operating system of the at least one execution unit, assigning at least one comparison logic for the purpose of execution on at least one computing core of the at least one execution unit in order to compare a first item of information relating to a first result of the execution of the first replica with a second item of information relating to a second result of the execution of the second replica in order to determine a comparison result, configuring a detection logic for the purpose of execution on at least one computing core of the at least one execution unit in order to detect the state of operation of the at least one execution unit depending on the comparison result, configuring an interface for the purpose of execution on at least one computing core of the at least one execution unit in order to read the first item of information and in order to read the second item of information by means of the interface, the interface providing the first item of information and the second item of information from at least one memory of the at least one execution unit for the purpose of access independent of the hardware and independent of the operating system of the at least one execution unit.

Advantageously, the first replica is assigned to a first computing core of the at least one execution unit for the purpose of execution, and the second replica being assigned to the first computing core of the at least one execution unit for the purpose of execution, the at least one execution unit being configured to execute the first replica and the second replica in sequence.

Advantageously, the first replica is assigned to a first computing core of the at least one execution unit for the purpose of execution, the second replica being assigned to a second computing core of the at least one execution unit for the purpose of execution, the at least one execution unit being configured to execute the first replica and the second replica in parallel.

Preferably, the comparison logic comprises a plurality of processes which are designed to communicate with one another via messages, the processes of the comparison logic being assigned to a plurality of computing cores of the at least one execution unit for the purpose of distributed execution.

Preferably, the first replica, the second replica and the comparison logic are configured as the first logical unit, a third replica of the application software, a fourth replica of the application software and an additional comparison logic being configured as the second logical unit, the first logical unit and the second logical unit being configured to synchronise at least one parameter, which defines a state of the first logical unit and a state of the second logical unit.

Preferably, the first logical unit is configured to communicate information relating to the at least one parameter by means of a signal to the second logical unit.

Preferably, the first replica is configured to invoke a function and the second replica is configured to invoke the same function, a function interface being configured to return a function result in response to a first invocation of the function by means of the first replica, and the function interface being configured to return the same function result in response to a second invocation of the function by means of the second replica.

Preferably, an input data interface is configured to specify the same input data for the first replica and for the second replica for the purpose of execution on the at least one computing core.

Preferably, the method additionally comprises the steps of: assigning at least one first comparison logic for the purpose of execution on the at least one computing core of the at least one execution unit in order to compare the first item of information relating to the first result of the execution of the first replica with the second item of information relating to the second result of the execution of the second replica in order to determine a first comparison result, assigning at least one second comparison logic for the purpose of execution on the at least one computing core of the at least one execution unit in order to compare the first item of information relating to the first result of the execution of the first replica with the second item of information relating to the second result of the execution of the second replica in order to determine a second comparison result, configuring the detection logic to detect the state of operation of the at least one execution unit depending on the first comparison result and depending on the second comparison result.

The method for detecting a state of operation of at least one execution unit comprises the steps of: executing a first replica of an item of application software on the at least one execution unit in order to calculate a first result, executing a second replica of the application software on the at least one execution unit in order to calculate a second result, comparing a first item of information relating to the first result with a second item of information relating to the second result in order to determine a comparison result, detecting the state of operation of the at least one execution unit depending on the comparison result, the first replica being assigned to at least one computing core of the at least one execution unit for the purpose of execution depending on an item of hardware or an operating system of the at least one execution unit, the second replica being assigned to the at least one computing core of the at least one execution unit for the purpose of execution depending on the hardware or the operating system of the at least one execution unit, and reading the first item of information and the second item of information by means of an interface, which provides the first item of information and the second item of information from at least one memory of the at least one execution unit for the purpose of access independent of the hardware and independent of the operating system of the at least one execution unit.

Preferably, the first replica is assigned to a first computing core of the at least one execution unit, the second replica being assigned to the first computing core of the at least one execution unit for the purpose of execution, the at least one execution unit being configured to execute the first replica and the second replica in sequence.

Preferably, the first replica is assigned to a first computing core of the at least one execution unit for the purpose of execution, the second replica being assigned to a second computing core of the at least one execution unit for the purpose of execution, the at least one execution unit being configured to execute the first replica and the second replica in parallel.

Preferably, the comparison involves several processes which are designed to communicate with one another via messages, the processes being assigned to a plurality of computing cores of the at least one execution unit for the purpose of distributed execution.

Preferably, the first replica, the second replica and a comparison logic for comparing the first item of information with the second item of information are configured as the first logical unit, a third replica of the application software, a fourth replica of the application software and an additional comparison logic for comparing a third item of information relating to a third result of an execution of the third replica with a fourth item of information relating to a fourth result of an execution of the fourth replica being configured as the second logical unit, the first logical unit and the second logical unit being configured to synchronise at least one parameter which defines a state of the first logical unit and a state of the second logical unit.

Preferably, the first logical unit is configured to communicate information relating to the at least one parameter by means of a signal to the second logical unit.

Preferably, the first replica is configured to invoke a function and the second replica is configured to invoke the same function, a function interface being configured to return a function result in response to a first invocation of the function by means of the first replica, and the function interface being configured to return the same function result in response to a second invocation by means of the second replica.

Preferably, an input data interface is configured to specify the same input data for the first replica and for the second replica for the purpose of execution on the at least one computing core.

Preferably, the method comprises the steps of: executing at least one first comparison logic on the at least one computing core of the at least one execution unit in order to compare the first item of information relating to the first result of the execution of the first replica with the second item of information relating to the second result of the execution of the second replica in order to determine a first comparison result, executing at least one second comparison logic on the at least one computing core of the at least one execution unit in order to compare the first item of information relating to the first result of the execution of the first replica with the second item of information relating to the second result of the execution of the second replica in order to determine a second comparison result, detecting the state of operation of the at least one execution unit depending on the first comparison result and depending on the second comparison result.

A corresponding device for configuring at least one execution unit in order to detect a state of operation of the at least one execution unit is designed to execute the method for the purpose of configuration.

A corresponding device for detecting the state of operation of at least one execution unit is designed to execute the method for the purpose of detecting a state of operation.

A computer program is designed to execute one of the methods.

Further advantageous embodiments can be found in the following description and in the drawings, in which:

FIG. 1 schematically shows parts of an execution unit,

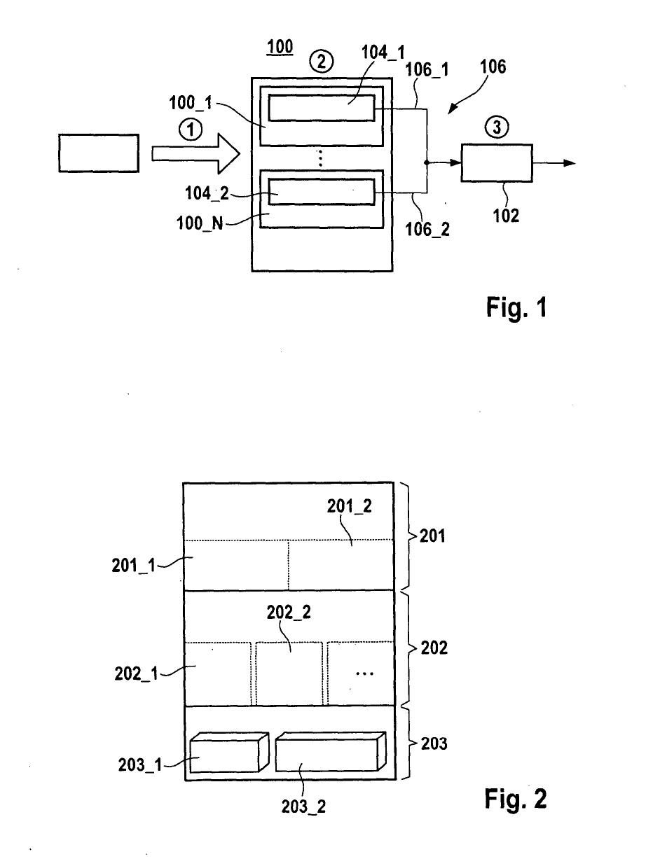

FIG. 2 schematically shows parts of the architecture of a software lockstep,

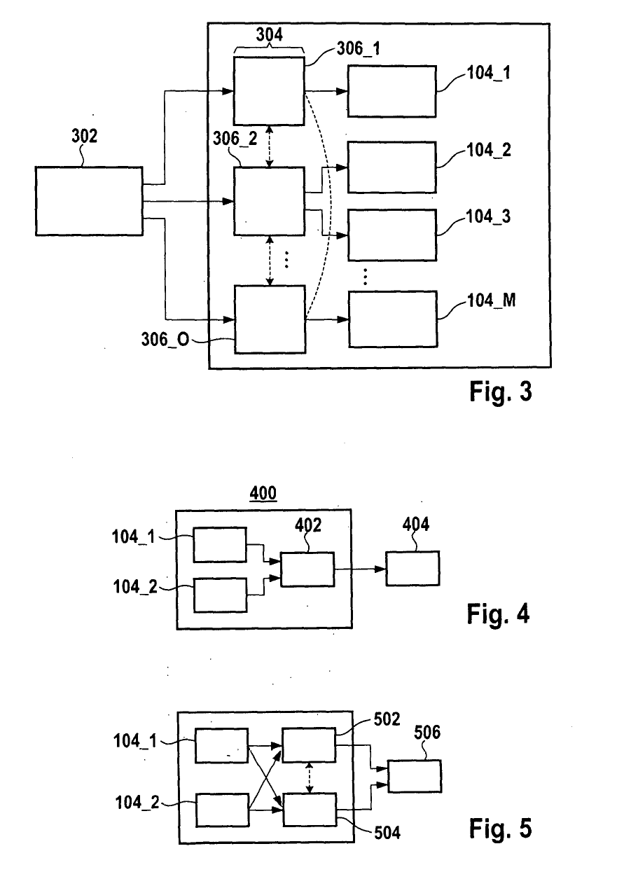

FIG. 3 schematically shows parts of an input data flow,

FIG. 4 schematically shows parts of a comparison logic,

FIG. 5 schematically shows parts of a first comparison logic and of a second comparison logic,

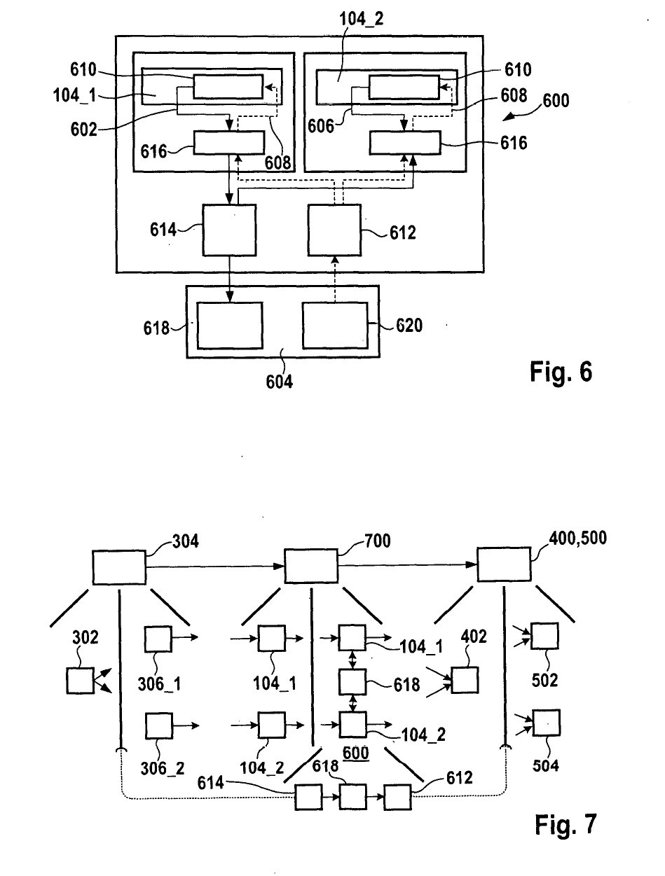

FIG. 6 schematically shows a function interface,

FIG. 7 schematically shows parts of a configuration protocol,

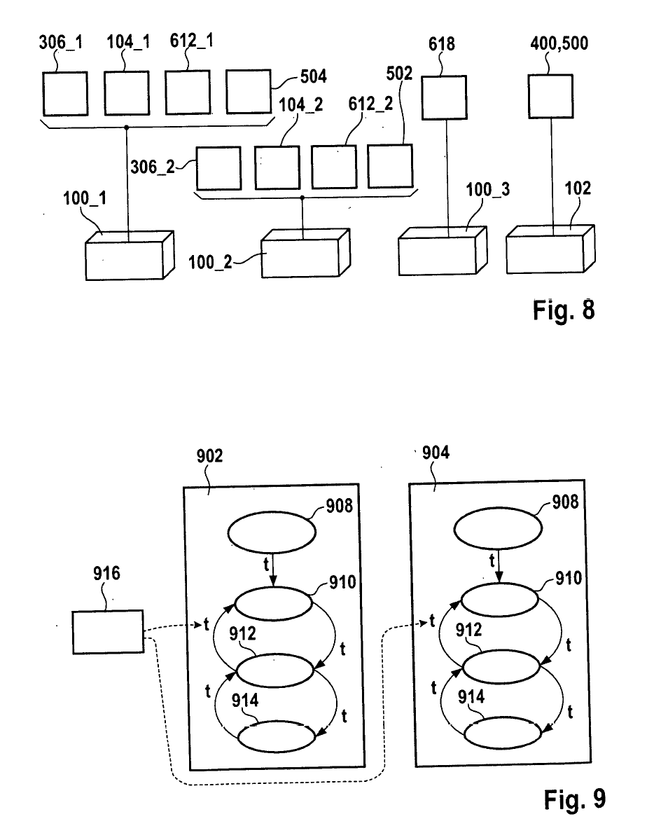

FIG. 8 schematically shows parts of an allocation process,

FIG. 9 schematically shows parts of a control process.

FIG. 1 schematically shows parts of an execution unit 100. The at least one execution unit 100 can be configured for a software lockstep method. The at least one execution unit 100 is designed to execute the software lockstep method as described in the following.

The at least one execution unit 100 comprises one or more computing cores 100-1, . . . , 100-N. For example, the execution unit comprises N=2 or N=4 computing cores. An execution unit is, for example, a multicore processor on which one or more computing cores 100-1, . . . , 100-N are arranged. The at least one execution unit 100 may also comprise a plurality of processors comprising a core or a plurality of multicore processors.

The at least one execution unit 100 is designed to execute a first replica 104-1 of an item of application software on the at least one execution unit 100 in order to calculate a first result. In the example, the first replica 104-1 is executed on a first computing core 100-1. The at least one execution unit 100 is designed to execute a second replica 104-2 of the application software on the at least one execution unit 100 in order to calculate a second result. In the example, the second replica 104-2 is executed on a second computing core 100-2. In the example, the first replica 104-1 is assigned to the first computing core 100-1 for the purpose of execution depending on an item of hardware or an operating system of the at least one execution unit 100. The first replica 104-1 may also be assigned to a plurality of computing cores of the at least one execution apparatus 100 for the purpose of execution. In the example, the second replica 104-2 is assigned to the second computing core 100-2 for the purpose of execution depending on the hardware or operating system of the at least one execution unit 100. The second replica 104-2 may also be assigned to a plurality of computing cores of the at least one execution means 100 for the purpose of execution.

The at least one execution unit 100 is designed to detect a state of operation of the at least one execution unit 100. In particular, the at least one execution unit 100 is designed to detect an error state or an error-free state as a state of operation. In addition, the at least one execution unit 100 may be designed to correct an error depending on the state of operation and to continue with the execution of the calculations or to handle the error in an error handling operation without continuing with the execution of the calculations. This functionality is also referred to in the following as lockstep.

The at least one execution means 100 is designed to compare a first item of information relating to the first result with a second item of information relating to the second result in order to determine a comparison result. The at least one execution unit 100 is designed to detect the state of operation of the at least one execution unit 100 depending on the comparison result. In the example, an error-free state is detected if, depending on the first item of information and the second item of information, it is detected that the first result and the second result match. In the example, an error state is detected if, depending on the first item of information and the second item of information, it is detected that the first result deviates from the second result.

The first item of information and the second item of information are read by means of an interface 106, which provides the first item of information and second item of information from at least one memory of the at least one execution unit for the purpose of access independent of the hardware and independent of the operating system of the at least one execution unit. On the one hand, the interface 106 accesses the at least one memory by means of instructions that are adapted to the hardware and to the operating system. For this purpose, the interface 106 is configurable depending on the hardware used and the operating system used. On the other hand, the interface 106 outputs the first item of information and the second item of information independently of the hardware and independently of the operating system.

In the example, the at least one execution unit 100 comprises a microcontroller 102, which reads the first item of information and the second item of information via the interface 106. The microcontroller 102 is designed to read the first result, for example, via a first data interface 106-1 from a first memory or a first memory region in which the first computing core 104-1 stores the first result. The microcontroller 102 is designed to read the second result, for example, via a second data interface 106-2 from a second memory or a second memory region in which the second computing core 104-2 stores the second result. Via the first data interface 106-1 or the second data interface 106-2, the interface 106 converts a read access of the microcontroller 102, which takes place independently of hardware and independently of the operating system, into a memory access, which implements the first item of information and the second item of information depending on hardware and depending on the operating system.

The at least one execution unit 100 may be configured to execute the first replica 104-1 and the second replica 104-2 in sequence. The execution unit 100 may be configured to execute the first replica 104-1 and the second replica 104-2 in parallel.

The comparison may involve several processes which are designed to communicate with one another via messages, the processes being assigned to a plurality of computing cores 100-1, . . . , 100-N of the at least one execution unit 100 for the purpose of distributed execution.

FIG. 2 schematically shows parts of the architecture of a software lockstep.

The software lockstep can be applied to single-core, multicore and multiprocessor systems in the proposed form on account of wide-ranging configuration possibilities,

The functions of the software lockstep are converted into functional units which are independent of the hardware and operating system.

As a result, the functional units can be assigned to various hardware in a flexible manner. In order to realise the functional units and in order to exchange between the functional units, implementations and middleware that are dependent on the hardware and operating system, for example the interface 106, are used.

The architecture of the software lockstep consists of three levels, as shown in FIG. 2.

The first level 201 forms the core functionalities that are independent of the operating system and hardware.

Said first level comprises initialisation 201-1 and processing of the logical units 201-2, e.g. replicas 104-1, . . . , 104-N and comparator.

The initialisation comprises the procedures for creating the logical units, including replicating the application software and the distribution thereof to various execution units.

The second level 202 is the platform-dependent implementation level, which uses various communication media and operating system functions in accordance with the infrastructure used in order to carry out the tasks of the logical core functionalities. A first implementation 202-1 according to the POSIX specification and a second implementation 202-2 according to the AUTOSAR specification are shown as middleware in FIG. 2 as an example for realising the platform-dependent implementation.

The third level 203 forms the hardware used. The choice of hardware determines which parts of the at least one execution unit, e.g. CPU or computing core, are used for implementing redundancy by means of the software lockstep. For example, a multicore system 203-1 and a multiprocessor system 203-2 are provided.

In order to be able to execute replicas in parallel, at least two single-core or one or more multicore processors are used.

The data exchange between the logical units takes place in accordance with the hardware used via inter- and intra-processor communication. An example of allocation to hardware components is illustrated in FIG. 8 and is described in the following.

FIG. 3 schematically shows parts of an input data flow from an external input data source 302. An input data interface 304 is configured to specify the same input data for the first replica 104-1, the second replica 104-2 and additional replicas 104-3, . . . , 104-M for the purpose of execution on the at least one computing core. Input data flows are shown in FIG. 3 in the form of solid arrows. An information flow via the received input data is shown in FIG. 3 by means of dashed arrows.

The input data interface 304 forms, for example, a logical unit of the software lockstep.

In addition to a central distribution of the input data from an external input data source 302, a decentral distribution of the input data is possible.

A decentral distribution means that the input data are provided by a plurality of external sources. This may be a trustworthy switch, for example, as a result of which input data are made available to the software lockstep.

The input data interface 304 comprises at least one input data management unit 306-1, . . . , 306-O.

Each input data management unit 306-1, . . . , 306-O is designed to receive data from the external input data source 302 and to forward said data to specified or specifiable replicas 104-1, . . . , 104-M.

Depending on the trustworthiness of the sending mechanism from the external input data source 302 to the input data management unit 306-1, . . . , 306-O, a selection may be provided as to which data the respective input data management units 306-1, . . . , 306-O should forward. In order to be able to guarantee that all replicas 104-1, . . . , 104-M are able to calculate the same result, it is necessary that the input data lead to identical results from the point of view of the application software. For this purpose, in the first step, each input data management unit 306-1, . . . , 306-O informs all other input data management units 306-1, . . . , 306-O of application-specific information relating to the data received. In the second step, it is determined which input data should be forwarded by each input data management unit to the respective specified replicas 104-1, . . . , 104-M. This determination can in this case be carried out in each input data management unit 306-1, . . . , 306-O or by means of a central calculation component, i.e. in a comparable manner to a master input data management unit.

In the third and final step, the input data management units 306-1, . . . , 306-O forward the now matched input data to the respective specified replicas 104-1, . . . , 104-M.

An example for the determination of this kind of the input data to be forwarded is the determination of data packets received by all input data management units 306-1, . . . , 306-O in an error-free manner. In the example comprising the switch, it may be the case that input data management unit 306-1 determines by means of a check sum that it has correctly received only the first three of five packets. For example, none of the additional input data management units 306-2, . . . , 306-O has received the first packet, but they have correctly received the remaining four packets.

In this case, all input data management units 306-1, . . . , 306-O determine that the replicas 104-1, . . . , 104-M comprising pockets two and three as input data are launched.

If there is only one unit for input data management, there is no need for information exchange. The second input data management unit 306-2 can then carry out distribution of the input data to the second replica 104-2 and the third replica 104-3. The second input data management unit 306-2 then has the task of data forwarding, for example. Additionally or alternatively, an application-dependent assessment of the input data is provided. For example, it is determined whether the data lie within a particular range of values.

The input data management units 306-1, . . . , 306-O may, instead of data, also send information as to which input data (packets) should be used, or as to where said data can be found in the memory. This requires the replicas 104-1, . . . , 104-M to have direct access to the input data. The application software comprising the corresponding input data is then executed within the replicas.

FIG. 4 schematically shows parts of a comparison logic 402. The comparison logic 402 comprises a comparator, which compares the information relating to the first result with the information relating to the second result.

For this purpose, the comparison logic 402 is executed on the at least one computing core of the at least one execution unit 100 in order to compare the first item of information relating to the first result of the execution of the first replica 104-1 with the second item of information relating to the second result of the execution of the second replica 104-2 in order to determine a first comparison result.

The state of operation of the at least one execution unit 100 is detected depending on the first comparison result and is sent to an external output data receiver 404.

FIG. 5 schematically shows parts of a first comparison logic 502 and a second comparison logic 504. The first comparison logic 502 comprises a first cross comparator, the second comparison logic 504 comprises a second cross comparator. The first cross comparator has the function of the comparator of the previously described comparison logic 402. The second cross comparator has the function of the comparator of the previously described comparison logic 402. In addition, the cross comparators communicate as described in the following.

The first comparison logic 502 and the second comparison logic 504 are executed on the at least one computing core 100-1, . . . , 100-N of the at least one execution unit 100 in each case in order to compare the first item of information relating to the first result of the execution of the first replica 104-1 with the second item of information relating to the second result of the execution of the second replica 104-2 in order to determine the first comparison result by means of the first cross comparator or to determine a second comparison result by means of the second cross comparator.

The state of operation of the at least one execution unit 100 is detected depending on the first comparison result and depending on the second comparison result by means of an item of information relating to the received output data, which are exchanged between the first comparison logic 502 and the first cross comparator and the second comparison logic 504, for example the second cross comparator via a signal connection 508. The state of operation is sent to an external output data receiver 506, for example by means of both cross comparators.

FIG. 6 schematically shows parts of a function interface 600. An input data flow is shown in FIG. 6 by means of dashed arrows, and an output data flow is shown in FIG. 6 by means of solid arrows. The first replica 104-1 may be configured to,a first invocation 602 of a function 604. The second replica 104-2 may be configured to a second invocation 606 of the same function 604. The function interface 600 is then configured, in response to the first invocation 602 of the function 604 by means of the first replica 104-1, to return a function result 608 and, in response to the second invocation 606 by means of the second replica 104-2, to return the same function result 608.

As a result, each replica can access non-replicated environment resources, such as input/output devices, during the running time of said replicas. The software components to be replicated do not have to adhere to the input-process-output model (IPO) for this purpose.

For this purpose, a function 610 is invoked within the replicated application software that shows an input or output. This is referred to in the following as external function. An example of an external function of this kind is the invocation of a random number generator. Since various replicas are invoked, since the application input data must be deterministic again and since the external function is merely available, potentially depending on resources, temporal synchronisation and matching of the data to be exchanged takes place.

This is achieved in that each function forms a separate logical unit which are connected to an external function input data management system 612 and an external function comparator 614. Technically, the invocation of an external function within the application software is achieved such that, during execution of the application software, more specifically within the replicas, a wrapper function 616 instead of the actual function invocation is invoked. The wrapper function 616 then activates the external function input data management system 612.

The output data are received by an external output data receiver 618. The input data are sent by an external input data source 620.

FIG. 6 shows the external function comparator 614 and the external function input data management system 612 in each case in a block for reasons of simplification. As a development, the previously described cross comparator unit (FIG. 5) and/or a plurality of the previously described input data management units (FIG. 3) is/are possible, or a comparator and a master input data management unit.

It is also possible to dispense with one of the units if said unit is not appropriate for the particular use. For example, in the case of a random number generator, the external function comparator 614 is not required as the external function. Both the external function comparator 614 and the external function input data management system 612 may be used a) for temporal synchronisation and b) for data comparison.

FIG. 7 schematically shows parts of a configuration process of the at least one execution means 100. Previously described elements having the same function are denoted with the same reference signs in FIG. 7.

Input data are by the input data source 302 via the input data management system 304, more specifically the input data management units 306-1, . . . , 306-M, in order to execute 700 the replicas 104-1, . . . , 104-N. The execution 700 may also comprise the external functions 618. The replicas 104-1, . . . , 104-N in this case communicate via the function interface 600, more specifically the external function comparator 614, the external function input data management system 612.

The comparison logic 402, 502, 504 evaluate the execution 700. The data flows, for example, via a buffer management system in the memory of the at least one execution unit 100.

FIG. 8 schematically shows parts of an allocation process of the logical units to computing cores. The reference signs of previously described elements having a comparable function are the same in FIG. 8.

The first input data management units 306-1, the first replica 104-1, a first external function input data management system 612-1 and the first cross comparator, i.e. the first comparison logic 502, are assigned to the first computing core 100-1. The first computing core 100-1 is for example a first or a second computing core of an execution means that is designed as a multicore system comprising four computing cores.

The second input data management units 306-2, the second replica 104-2, a second external function input data management system 612-2 and the second cross comparator, i.e. the second comparison logic 504, are assigned to the second computing core 100-2. The second computing core 100-2 is, for example, a third or a fourth computing core of the execution means that is designed as a multicore system comprising four computing cores.

The external function 618 is assigned to the third computing core 100-3. The third computing core 100-3 is, for example, one of the computing cores of an execution means that is designed as a multicore system comprising two computing cores.

The comparison function 400, 500 is assigned to the microcontroller 102. The microcontroller 102 for example has an integrated hardware lockstep function.

FIG. 9 schematically shows parts of a control process. If the execution of the application software requires the replicas to be synchronised at specific timepoints, a software lockstep framework provides corresponding synchronisation mechanisms.

The first replica 104-1, the second replica 104-2 and a comparison logic 402, 502, 504 for comparing the first item of information with the second item of information are for example configured as the first logical unit 902.

A third replica of the application software and a fourth replica of the application software may be provided. Then, as described above, a third item of information relating to a third result of an execution of the third replica is compared with a fourth item of information relating to a fourth result of an execution of the fourth replica. For this purpose, an additional comparison logic 402, 502, 504 is preferably provided, which is arranged on an additional microcontroller or one of the computing cores 100-1, . . . , 100-N.

The third replica, the fourth replica and the additional comparison logic 402, 502, 503 are for example configured as the second logical unit 904.

The control between the logical units is achieved by means of signals. Each logical unit comprises a state machine, the transitions of which can be triggered by means of configurable signals. For example, the input data management system also sends a signal in addition to the input data to the corresponding replicas, such that upon reception of said signal, said replicas can change their state and begin with the execution of the application software.

Additional signals for the purpose of synchronisation with, for example, a fixed time management system, can also be integrated. An example of this is a comparator which starts every 10 ms and decides on the data available thereto.

The first logical unit 902 and the second logical unit 904 are controlled and configured to synchronise at least one parameter t, which influences a state of the first logical unit 902 and a state of the second logical unit 904 or is used in a state of said logical units.

The first logical unit 902 is for example configured to communicate information relating to the at least one parameter t to the second logical unit 904 by means of a signal 906.

The first logical unit 902 and the second logical unit 904 are, for example, state machines which, during running of the application software, can for example identify the states of initialisation 908, ready 910, execution 912 and evaluate 914. Execution 912 relates for example to executing a function of the application software. Evaluate 914 relates for example to the comparison and detection. Initialisation 908 and ready 910 are for example states that relate to the application software, comparison or detection.

The state of initialisation 908 defines the at least one parameter t, for example a time. Then there is a transition to the state of execution 912 via the state of ready 910. The state can then change from execution 912 to ready 910 or value 912. The state can then change from evaluate 914 to execution 912. The at least one parameter t is sent to the second logical unit 904 after initialisation of the first logical unit 902. A corresponding control signal is shown as a dashed arrow in FIG. 9. Said second logical unit is synchronised, for example temporally, with the first logical unit 902. The at least one parameter t is then carried out during state changes, shown in FIG. 9 as a solid arrow. The first logical unit 902 and the second logical unit 904 thus use the same at least one parameter t in identical states.

It may also be possible for the at least one parameter t to be sent from an external component 916 to the first logical unit 902 and to the second logical unit 904.

If the application software invokes external functions during its execution, e.g. access to a random number generator or a system clock, all replicas obtain the same values, in the example the same random number or time.

A method for configuring the at least one execution unit 100 in order to detect a state of operation by means of the previously described method comprises the steps of: assigning the first replica 104-1 to the application software for the purpose of execution on at least one computing core 100-1, . . . , 100-N of the at least one execution unit 100 depending on information relating to at least one item of hardware or relating to at least one operating system of the at least one execution unit 100, assigning a second replica 104-2 to the application software for the purpose of execution on the at least one computing core 100-1, . . . , 100-N of the at least one execution unit 100 depending on the information relating to the at least one item of hardware or relating to the at least one operating system of the at least one execution unit 100, assigning at least one comparison logic 400, 502, 504 for the purpose of execution on at least one computing core 100-1, . . . , 100-M of the at least one execution unit 100 in order to compare a first item of information relating to a first result of the execution of the first replica 104-1 with a second item of information relating to a second result of the execution of the second replica 104-2 in order to determine a comparison result, configuring a detection logic for the purpose of execution on at least one computing core 100-1, 100-N of the at least one execution unit 100 in order to detect the state of operation of the at least one execution unit 100 depending on the comparison result, configuring an interface 106 for the purpose of execution on at least one computing core 100-1, . . . , 100-N of the at least one execution unit 100 in order to read the first item of information and in order to read the second item of information by means of the Interface 106, the interface 106 providing the first item of information and the second item of information from at least one memory of the at least one execution unit 100 for access independent of the hardware and independent of the operating system of the at least one execution unit 100.

The at least one execution unit 100 is optionally configured to execute the first replica 104-1 and the second replica 104-2 temporally in sequence or in parallel.

If the comparison logic 402, 502, 504 comprises a plurality of processors, the processes of the comparison logic 402, 502, 504 are optionally assigned to a plurality of computing cores of the at least one execution unit 100 for the purpose of distributed execution.

Optionally, the first replica 104-1, the second replica 104-2 and the comparison logic 402, 502, 504 are configured as the first logical unit 902, and the third replica 104-3, the fourth replica 204-4 and the additional comparison logic 402, 502, 504 are configured as the second logical unit 904. In this case, the first logical unit 902 and the second logical unit 904 are configured to synchronise at least one parameter t, which defines a state of the first logical unit 902 and a state of the second logical unit 904.

Optionally, the first logical unit 902 is configured to communicate information relating to the at least one parameter t by means of a signal to the second logical unit.

Optionally, the first replica 104-1 is configured to invoke a function 604, and the second replica 104-2 is configured to invoke the same function 604. The function interface 600 is configured to return a function result in response to a first invocation of the function 604 by means of the first replica 104-1, and the function interface 600 being configured to return the same function result in response to a second invocation of the function 604 by means of the second replica 104-2.

Optionally, an input data interface 304 is configured to specify the same input data for execution for the first replica 104-1 and the second replica 104-2.

Additionally, the steps of assigning the first comparison logic 502 for the purpose of execution on the at least one computing core 101-1, . . . , 101-N in order to determine the first comparison result and assigning the second comparison logic 504 for the purpose of execution on the at least one computing core 101-1, . . . , 101-N in order to determine the second comparison logic may be provided. Additionally, the detection logic may in this case be configured to detect the state of operation of the at least one execution unit 100 depending on the first comparison result and depending on the second comparison result.

A computer program is designed such that it comprises instructions that enable execution of the methods described.

The methods are executed on a device which is designed to implement the instructions if the computer program is running on the device. The methods or parts of the methods may be stored as instructions in a memory on the device.

Preferably, the methods are methods for an execution unit of a motor vehicle. Preferably, the device is an automotive microcontroller for use in motor vehicles. Preferably the computer program is designed for use in a motor vehicle.

Additional fields of application of the methods, device and computer program relate to use in the following fields:

—open- and closed-loop control of energy supply systems,

—open- and closed-loop control of production facilities,

—open- and closed-loop control in the field of avionics, shipping, aerospace and railroad vehicles,

—open- and closed-loop control in the field of military applications,

—reliable calculation systems in the financial sector,

—reliable domestic appliances,

—reliable applications in building automation,

—reliable applications in medical technology,

—reliable applications in construction machines.

1-21. (canceled)

2. A method for configuring at least one execution unit for detecting a state of operation a the at least one execution unit, the method comprising:
assigning a first replica of an item of application software for the purpose of execution on at least one computing core of the at least one execution unit depending on information relating to at least one item of hardware or relating to at least one operating system of the at least one execution unit;
assigning a second replica of the application software for the purpose of execution on the at least one computing core of the at least one execution unit depending on the information relating to the at least one item of hardware or relating to the at least one operating system of the at least one execution unit;
assigning at least one comparison logic for the purpose of execution on at least one computing core of the at least one execution unit in order to compare a first item of information relating to a first result of the execution of the first replica with a second item of information relating to a second result of the execution of the second replica in order to determine a comparison result;
configuring a detection logic for the purpose of execution on at least one computing core of the at least one execution unit in order to detect the state of operation of the at least one execution unit depending on the comparison result; and
configuring an interface for the purpose of execution on at least one computing core of the at least one execution unit in order to read the first item of information and in order to read. the second item of information by means of the interface, the interface providing the first item of information and the second item of information from at least one memory of the at least one execution unit for the purpose of access independent of the hardware and independent of the operating system of the at least one execution unit.

23. The method according to claim 22, wherein
the first replica is assigned to a first computing core of the at least one execution unit for the purpose of execution, and the second replica is assigned to the first computing core of the at least one execution unit for the purpose of execution, the at least one execution unit being configured to execute the first replica and the second replica in sequence.

24. The method according to claim 22, wherein
the first replica is assigned to a first computing core of the at least one execution unit for the purpose of execution and the second replica is assigned to a second computing core of the at least one execution unit for the purpose of execution, the at least one execution unit being configured to execute the first replica and the second replica in parallel.

25. The method according to claim 24, wherein
the comparison logic comprises a plurality of processes which are designed to communicate with one another via messages, the processes of the comparison logic being assigned to a plurality of computing cores of the at least one execution unit for the purpose of distributed execution.

26. The method according to claim 25, wherein
the first replica, the second replica and the comparison logic are configured as the first logical unit, a third replica of the application software, a fourth replica of the application software and an additional comparison logic being configured as the second logical unit, the first logical unit and the second logical unit being configured to synchronize at least one parameter, which defines a state of the first logical unit and a state of the second logical unit.

27. The method according to claim 26, wherein
the first logical unit is configured to communicate information relating to the at least one parameter by means of a signal to the second logical unit.

28. The method according to claim 27, wherein
the first replica is configured to invoke a function and the second replica is configured to invoke the same function, and wherein a function interface is configured to return a function result in response to a first invocation of the function by means of the first replica, and wherein the function interface is configured to return the same function result in response to a second invocation of the function by means of the second replica.

29. The method according to claim 28, wherein
an input data interface is configured to specify the same input data for the first replica and for the second replica.

30. The method according to claim 29, wherein
assigning at least one first comparison logic for the purpose of execution on the at least one computing core of the at least one execution unit in order to compare the first item of information relating to the first result of the execution of the first replica with the second item of information relating to the second result of the execution of the second replica in order to determine a first comparison result,
assigning at least one second comparison logic for the purpose of execution on the at least one computing core of the at least one execution unit in order to compare the first item of information relating to the first result of the execution of the first replica with the second item of information relating to the second result of the execution of the second replica in order to determine a second comparison result,
configuring the detection logic to detect the state of operation of the at least one execution unit depending on the first comparison result and depending on the second comparison result.

31. A method for detecting a state of operation of at least one execution unit, the method comprising:
executing a first replica of an item of application software on the at least one execution unit in order to calculate a first result;
executing a second replica of the application software on the at least one execution unit in order to calculate a second result;
comparing a first item of information relating to the first result with a second item of information relating to the second result in order to determine a comparison result;
detecting the state of operation of the at least one execution unit depending on the comparison result;
the first replica being assigned to at least one computing core of the at least one execution unit for the purpose of execution depending on an item of hardware or an operating system of the at least one execution unit and
the second replica being assigned to the at least one computing core of the at least one execution unit for the purpose of execution depending on the hardware or the operating system of the at least one execution unit wherein
reading the first item of information and the second item of information by means of an interface, which provides the first item of information and the second item of information from at least one memory of the at least one execution unit for the purpose of access independent of the hardware and independent of the operating system of the at least one execution unit.

32. The method according to claim 31, wherein
the first replica is assigned to a first computing core of the at least one execution unit and the second replica is assigned to the first computing core of the at least one execution unit for the purpose of execution, the at least one execution unit being configured to execute the first replica and the second replica in sequence.

33. The method according to claim 31, wherein
the first replica is assigned to a first computing core of the at least one execution unit for the purpose of execution and the second replica is assigned to a second computing core of the at least one execution unit for the purpose of execution, the at least one execution unit being configured to execute the first replica and the second replica in parallel.

34. The method according to claim 33, wherein
the comparison involves several processes which are designed to communicate with one another via messages, the processes being assigned to a plurality of computing cores of the at least one execution unit for the purpose of distributed execution.

35. The method according to claim 34, wherein
the first replica, the second replica and a comparison logic for comparing the first item of information with the second item of information are configured as the first logical unit, a third replica of the application software, a fourth replica of the application software and an additional comparison logic for comparing a third item of information relating to a third result of an execution of the third replica with a fourth item of information relating to a fourth result of an execution of the fourth replica being configured as the second logical unit, the first logical unit and the second logical unit being configured to synchronize at least one parameter which defines a state of the first logical unit and a state of the second logical unit.

36. The method according to claim 35, wherein
the first logical unit is configured to communicate information relating to the at least one parameter by means of a signal to the second logical unit.

37. The method according to claim 36, wherein
the first replica is configured to invoke a function and the second replica is configured to invoke the same function, and wherein a function interface is configured to return a function result in response to a first invocation of the function by means of the first replica, and wherein the function interface is configured to return the same function result in response to a second invocation by means of the second replica.

38. The method according to claim 37, wherein
an input data interface is configured to specify the same input data for the first replica and for the second replica for the purpose of execution on the at least one computing core.

39. The method according to claim 38, wherein
executing at least one first comparison logic on the at least one computing core of the at least one execution unit in order to compare the first item of information relating to the first result of the execution of the first replica with the second item of information relating to the second result of the execution of the second replica in order to determine a first comparison result,
executing at least one second comparison logic on the at least one computing core of the at least one execution unit in order to compare the first item of information relating to the first result of the execution of the first replica with the second item of information relating to the second result of the execution of the second replica in order to determine a second comparison result, and
detecting the state of operation of the at least one execution unit depending on the first comparison result and depending on the second comparison result.

40. A device for configuring said at least one execution unit in order to detect a state of operation of the at least one execution unit, wherein the device is designed to execute the method according to claim 22.

41. A device for detecting the state of operation of said at least one execution unit, wherein the device is designed to execute the method according to claim 31.

42. A computer program, designed to execute the method according to claim
